(19) United States
(12) Patent Application Publication
(10) Pub. No.: US 2023/0297947 A1
(43) Pub. Date: Sep. 21, 2023

(54) METHOD AND SYSTEM FOR ORDER PICKING

(71) Applicant: Quantiphi Inc, Marlborough, MA (US)

(72) Inventors: Akhil Adapa, Mumbai (IN); Mishall Swain, Mumbai (IN); Reghu Hariharan, Boston, MA (US)

(21) Appl. No.: 17/697,912

(22) Filed: Mar. 17, 2022

(51) Int. Cl. G06Q 10/08; G06T 7/10; G06V 10/764

(52) U.S. Cl. CPC G06Q 10/087; G06T 7/10; G06V 10/765; G06T 2207/20081

(57) ABSTRACT

Disclosed is method for order picking, method comprising: obtaining image frame captured by camera arranged on a pallet jack; processing image frame, using object detection model that is pre-trained, for generating first list, wherein said model identifies and localizes case(s) represented in image frame, first list includes one entry per image frame; processing image segment(s) representing case(s), using classification model that is pre-trained, for updating first list, classification model classifies product in given case as belonging to given class, predicts confidence score and generates identification code of product, first list is updated by adding confidence score and identification code to given entry; employing tracking algorithm for generating tracking list indicating count of cases picked per product for pallet, tracking algorithm utilizes first list; and providing, on display device, interactive user interface, in real time, for presenting count of cases picked per product for pallet.

### TECHNICAL FIELD

The present disclosure relates generally to machine learning; and more specifically, to methods and systems for order picking.

### BACKGROUND

With increase in consumerism, purchasing or products has increased, and logistics companies have expanded, resulting in a need for intelligent and time efficient order fulfilment procedures. Currently, objects have to be manually picked up from a warehouse and sent for transportation by pickers. Moreover, the warehouse pickers are required to maintain high accuracy while working with thousands of products every day. Typically, the warehouse pickers often work with pallets, and are required to move in the warehouse to collect the objects required for order fulfilment. Moreover, the pallet is required to be stacked with the objects evenly, with adequate weight distribution throughout the pallet, otherwise there is an increased risk of the pallet falling or toppling over during transportation and/or damage incurred to the objects, leading to additional requirement of effort. Typically, the objects have to be manually picked from storage and placed in dedicated bins.

Such order fulfilment procedures depend highly on human intellect and proficiency. However, the order fulfilment procedure is a time-consuming process as the picker has to move around a lot in order to collect the objects required for building an order, leading to manual errors. Furthermore, a high picking speed is required to complete the order fulfilment procedures on time, thereby increasing chances of mis-picking (i.e., incorrect picking). However, the picker receives no feedback with respect to the mis-pickings, hence the order is inaccurate. Additionally, the picker is not aware of the amount of work that has already been completed, and the number of objects required to complete an order. Conventionally, the existing systems and methods are time-consuming and prone to errors.

Therefore, in light of the foregoing discussion, there exists a need to overcome the aforementioned drawbacks associated with avoiding inaccuracies in shipping methods.

### SUMMARY

The present disclosure seeks to provide a method for order picking. The present disclosure also seeks to provide a system for order picking. An aim of the present disclosure is to provide a solution that overcomes at least partially the problems encountered in prior art.

In one aspect, the present disclosure provides a method for order picking, the method comprising:
obtaining an image frame captured by a camera arranged on a pallet jack, wherein the image frame represents a view of cases picked for a given pallet that is arranged on the pallet jack;
processing the image frame, using an object detection model that is pre-trained, for generating a first list, wherein the object detection model at least identifies and localizes at least one case represented in the image frame, and wherein the first list includes at least one entry per image frame, a given entry corresponding to a given case that is identified to be arranged on the given pallet in a given frame and metadata of a bounding box for the given case;
processing at least one image segment representing the at least one case in the image frame, using a classification model that is pre-trained, for updating the first list, wherein the classification model classifies a product in the given case as belonging to a given class, predicts a confidence score of said classification and generates an identification code of the product, and wherein the first list is updated by adding the confidence score and the identification code to the given entry;
employing a tracking algorithm for generating a tracking list indicative of at least a count of cases picked per product for the given pallet, wherein the tracking algorithm utilizes the first list; and
providing, on a display device, an interactive user interface for presenting, in real time, at least the count of cases picked per product for the given pallet.

In another aspect, the present disclosure provides a system for order picking, the system comprising a camera, a display device, and at least one processor, wherein the at least one processor is configured to:
obtain an image frame captured by the camera arranged on a pallet jack, wherein the image frame represents a view of cases picked for a given pallet that is arranged on the pallet jack;
process the image frame, using an object detection model that is pre-trained, for generating a first list, wherein the object detection model at least identifies and localizes at least one case represented in the image frames, and wherein the first list includes at least one entry per image frame, a given entry corresponding to a given case that is identified to be arranged on the given pallet in a given frame and metadata of a bounding box of the given case;
process at least one image segment representing the at least one case in the image frame, using a classification model that is pre-trained, for updating the first list, wherein the classification model classifies a product in the given case as belonging to a given class, predicts a confidence score of said classification and generates an identification code of the product, and wherein the first list is updated by adding the confidence score and the identification code to the given entry;
employ a tracking algorithm for generating a tracking list indicative of at least a count of cases picked per product for the given pallet, wherein the tracking algorithm utilizes the first list; and
provide, on the display device, an interactive user interface for presenting, in real time, at least the count of cases picked per product for the given pallet.

Embodiments of the present disclosure substantially eliminate or at least partially address the aforementioned problems in the prior art, and enable efficient and accurate order fulfilment.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 illustrates steps of a method for order picking, in accordance with an embodiment of the present disclosure;

FIG. 2 illustrates an exemplary process flow of a method for order picking, in accordance with an embodiment of the present disclosure;

FIG. 3 illustrates an exemplary detailed high-level process flow of a method for order picking, in accordance with an embodiment of the present disclosure;

FIG. 4 illustrated is an exemplary processing sequence for each image frame with focus on a tracking algorithm, in accordance with an embodiment of the present disclosure;

FIG. 5 illustrates an exemplary interactive user interface, in accordance with an embodiment of the present disclosure;

FIG. 6 illustrates an architecture of a system for order picking, in accordance with an embodiment of the present disclosure;

FIG. 7 illustrates a schematic illustration of a system for order picking, in accordance with an embodiment of the present disclosure; and

FIGS. 8 and 9 illustrate views that are captured by a camera mounted on a pallet jack, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method for order picking, the method comprising:
obtaining an image frame captured by a camera arranged on a pallet jack, wherein the image frame represents a view of cases picked for a given pallet that is arranged on the pallet;
processing the image frame, using an object detection model that is pre-trained, for generating a first list, wherein the object detection model at least identifies and localizes at least one case represented in the image frame, and wherein the first list includes at least one entry per image frame, a given entry corresponding to a given case that is identified to be arranged on the given pallet in a given frame and metadata of a bounding box for the given case;
processing at least one image segment representing the at least one case in the image frame, using a classification model that is pre-trained, for updating the first list, wherein the classification model classifies a product in the given case as belonging to a given class, predicts a confidence score of said classification and generates an identification code of the product, and wherein the first list is updated by adding the confidence score and the identification code to the given entry;
employing a tracking algorithm for generating a tracking list indicative of at least a count of cases picked per product for the given pallet, wherein the tracking algorithm utilizes the first list; and
providing, on a display device, an interactive user interface for presenting, in real time, at least the count of cases picked per product for the given pallet.

In another aspect, an embodiment of the present disclosure provides a system for order picking, the system comprising a camera, a display device, and at least one processor, wherein the at least one processor is configured to:
obtain an image frame captured by the camera on a pallet jack, wherein the image frame represents a view of cases picked for a given pallet that is arranged on the pallet;
process the image frame, using an object detection model that is pre-trained, for generating a first list, wherein the object detection model at least identifies and localizes at least one case represented in the image frames, and wherein the first list includes at least one entry per image frame, a given entry corresponding to a given case that is identified to be arranged on the given pallet in a given frame and metadata of a bounding box for the given case;
process at least one image segment representing the at least one case in the image frame, using a classification model that is pre-trained, for updating the first list, wherein the classification model classifies a product in the given case as belonging to a given class, predicts a confidence score of said classification and generates an identification code of the product, and wherein the first list is updated by adding the confidence score and the identification code to the given entry;
employ a tracking algorithm for generating a tracking list indicative of at least a count of cases picked per product for the given pallet, wherein the tracking algorithm utilizes the first list; and
provide, on the display device, an interactive user interface for presenting, in real time, at least the count of cases picked per product for the given pallet.

The present disclosure provides the aforementioned method and system for order picking. Herein, the cases (and thereby, products) are dynamically monitored continuously during the order picking, wherein the number of cases being picked are constantly updated in real time or near-real time, and this count is displayed. As a result, chances of errors being made by the person are substantially reduced. Furthermore, in case the count of cases picked by a person is incorrectly determined by the system, it is corrected manually by the person. Moreover, the aforementioned method and system allows the person to accurately fulfil their targets since the number of cases picked per product are continuously being tracked and shown to the person on the interactive user interface. This is advantageous for reducing inaccuracies during transportation without compromising on speed of the order picking.

Throughout the present disclosure, the term “order picking” refers to a process of picking a case of a product from its place in a storage facility and placing the case on a pallet. The pallet is a standard pallet that is loaded on a pallet jack that is driven by a person performing the order picking. Typically, the order picking is a first stage in fulfilling an order of a customer, and an efficient order picking is able to make sure that the product and/or case picked up is the right product and/or right case and is picked up in the correct quantity that is required.

Throughout the present disclosure, the term “processor” relates to a computational element that is operable to respond to and processes instructions that drive the system. The at least one processor is communicably coupled with the camera and the display device. Optionally, the at least one processor is implemented as a graphical processing unit (GPU). The GPU processes the image frames in an accelerated manner in real time and improves execution speed of various machine learning models. The at least one processor, in operation, implements the method for order picking. Furthermore, the term “processor” may refer to one or more individual processors, processing devices and various elements associated with a processing device that may be shared by other processing devices. Such processors, processing devices and elements may be arranged in various architectures for responding to and executing the steps of the method.

Throughout the present disclosure, the term “case” is a standard shipping unit, multiple products are typically grouped together and packed in a case, wherein the case is built per product. Typically, the case is in form of a box. The case can be a specific number of eaches, wherein the eaches are shrink-wrapped or packaged in a tray or a shell. Herein, the term “eaches” is used to describe a unit of measure that refers to each individual product. Furthermore, the term “pallet” refers to a structure that is used to hold a load of several cases for shipping. Commonly, the case may be interchangeably referred using following terms: pack, orderable pack, supplier pack, vendor pack, case box and case pack. Optionally, the given pallet is selected and is then manually arranged on the pallet jack. In an embodiment, the given pallet is selected automatically. In such a case, the given pallet may be selected according to one or more criterion such as sequence for order fulfilment, a status of inventory of the storage facility, and so forth. In another embodiment, the given pallet is selected based on an input from the person performing order picking in the storage facility, wherein the input is received prior to the person building the given pallet.

Throughout the present disclosure, the term “pallet jack” refers to a tool used to lift and move pallets within the warehouse. Notably, the camera, the display device, and the at least one processor of the system are arranged on the pallet jack. The pallet jack is steered by the person with the help of a lever that also acts as a pump handle for raising the pallet jack. The pallet jack comprises forks that hold the pallets from a bottom side of the pallets, and front wheels are present on inside at front end of the forks. The forks of the pallet jack may be lifted up or down using hydraulic pumping, wherein the pallet is only lifted enough to clear floor for subsequent travel.

The image frame is captured by the camera, wherein the capturing of the image frame depends on attributes associated with the camera. The attributes associated with the camera may be, depth of field, motion blur, shutter speed, aperture, distortions of lens, resolution, focal length, frames per second (FPS) and so forth. The camera may be selected in a manner that it captures high-quality (i.e., high resolution) image frames. Optionally, the camera is implemented as a visible-light camera. As an example, the camera may be implemented as a Red-Green-Blue (RGB) camera. The conditions in the storage facility may, for example, be lighting conditions. Furthermore, the camera is mounted on the pallet jack in a manner that the cases and the pallet are effectively captured by the camera. In other words, a pose of the camera is set (manually) to be such that a required view is captured by the camera in the image frame. In particular, the pose of the camera is set or adjusted to be such that the cases and the pallet are in a field of view of the camera, and are thus represented in the image frame. Moreover, several image frames are captured at different instances of time, throughout the process of order picking. Furthermore, the image frame is captured to get a clear view of the case along with identification markers of the case, wherein the identification markers may be a part number, a serial number, a tracking number, an ID label, a bar code, a QR code, a picture, name on a cover of the product, logo, design, and so forth. Furthermore, the identification marker is a stock keeping unit (SKU), wherein the SKU is a distinct type of an individual product or at least one case that corresponds to a unique product. The at least one case is tracked in a first list, such as the at least one case and all attributes associated with type of the at least one case that distinguish it from other cases represented in the image frame.

Typically, the attributes of the at least one case may include manufacturer name, brand name, description, material, size, color, packaging, warranty terms and so forth. The attributes of the at least one case are properties that describe the product in the at least one case. The attributes help the person to distinguish between the products, and present mis-pickings. The attributes further help in classification of the products. For instance, a beverage company may produce two beverages in respective bottles, namely “Drink A” and “Drink B”. Herein, the manufacturer name, brand name, material of the bottle, size of the bottle, quantity, packaging of both the beverages of the “Drink A” and “Drink B” are same. However, color of the “Drink A” is different from color of the “Drink B”. In this case, determining the attributes of the “Drink A” and “Drink B” are important so that the two beverages are not incorrectly grouped together.

The image frame is sent from the camera to the at least one processor for processing. The object detection model is machine learning or deep learning model, which is used to replicate human ability of looking at images or video, to recognize and locate objects of interest within a matter of moments. In the present disclosure, the object detection model is pre-trained to accurately detect presence and location of the at least one case represented in the image frame. The object detection model identifies the at least one case from the image frame and detects the SKU related to the at least one case. The at least one processor localizes all SKU within the image frame. Furthermore, the object detection model localizes the at least one case by identifying the at least one bounding box surrounding the at least one case in the image frame. Herein, the bounding box is defined by ‘x’ and ‘y’ coordinates of its vertices to describe a spatial location of the at least one case in the image frame. Optionally, the object detection model further comprises localizing packs represented in the image frame.

In an embodiment, the first list includes metadata of the bounding box for the given case. Herein, the metadata may be a descriptive information, mathematical information, and similar, about the bounding box, which is used for discovery, identification and further processing purposes, wherein length of the metadata per given entry may not be constant, and the size of the metadata of the given entry is usually much less than the plurality of image frames. Such metadata is easy to store and process.

In an embodiment, the object detection model also identifies and localizes the given pallet represented in the image frame. Additionally, the object detection model localizes the given pallet by identifying the at least one bounding box surrounding the given pallet in the image frame, and determines the spatial location of the given pallet in the image frame. In case the given pallet is empty, the object detection model does not output any bounding box corresponding to cases picked for the given pallet.

The at least one image segment is processed, wherein the at least one image segment is a portion of the image frame which represents the at least one case within the image frame. Optionally, the at least one image segment is isolated from the image frame in order to perform detailed analysis of the at least one case. Herein, the method further comprises optionally cropping the at least one image segment from the image frame, where at least one image segment represents the at least one case. Subsequently, the at least one image segment is sent to the classification model, wherein the classification model predicts a class or a category for products in the at least one case. Herein, the class of the products in the at least one case refers to a category of products sharing similar characteristics (for example, sharing similar visual features). The class may be a pre-known class or may be defined by the classification model. Furthermore, the class may be divided into further sub-classes, to improve accuracy of the classification model. In an embodiment, the class of the products in the at least one case relates to a type of packaging of the products. The type of packaging can be identified based on visual features of the at least one case and/or visual features of the products in the at least one case. As an example, the class of the given product in a given case may be “Bottle”, “Can”, “Fridge Pack”, “Pouch”, “Sachet”, “Tetra Pack”, and the like. In an embodiment, the class of the products in the at least one case relates to a type of the product. Examples of such classes of the products may include, but are not limited to, “Beverages”, “Sauces”, “Dips”, “Seasoning”, “Spices”, “Flours”, “Chemicals”, “Storage Containers”, “Utensils”, “Soft furnishings”, and the like.

Additionally, the given case is built per product, and the classification model classifies the products according to its unique visual features, to a particular class. In an example, a given product may be present in the given case. Herein, the classification model is pre-trained and may have two pre-defined classes, such as “Class A” and “Class B”, for classifying products. Subsequently, the classification model may classify the given product to belong to “Class A” and may also predict the confidence score of placing the given product in “Class A”. For example, the given case may comprise eaches of bottles, so the given product may be classified into the Class A which may be “Bottles”. Herein, the confidence score of said classification is an indication of an extent of correctness of the classification, according to the classification model. The confidence score may be in form of a numerical value, wherein the numerical value may lie in a range from 0 to 1, or 0 to 100, and so on. Alternatively, the confidence score may be in form of a percentage, between range of 0% to 100%. Alternatively, the confidence score may be in form of comparative terms, such as: “High”, “Medium”, “Low”, and so forth. Optionally, a given product is classified to belong to a given class when the confidence score lies in a range of 51% to 100%. More optionally, the given product is classified more confidently when the confidence score lies in a range of 70% to 100%. As an example, the confidence score may lie in a range from 70%, 75%, 80% or 85% up to 77%, 84%, 93% or 100%. Continuing the previous example, the classification model may classify the first product to “Class A” with the confidence score of ‘90%’. Simultaneously, the classification model may classify the second product to “Class B” with the confidence score of ‘70%’. Herein, the confidence score of ‘90%’ of classifying the first product in “Class A” means that output of the classification model has a ‘90%’ chance of being correct, and the confidence score of ‘70%’ of classifying the second product in “Class B” means that output of the classification model has a ‘70%’ chance of being correct. Ideally, for a product in the given case to be confidently classified into a particular class, the confidence score should be more than ‘50%’ (or greater than 5 (for the range of 1-10), or greater than 50 (for the range of 1-100), or similar), which means that the output of the classification model has more than a ‘50%’ chance of being correct. Thereafter, once the product in the given case is confidently classified by the classification model, the identification code is generated, wherein the identification code is a unique identifier, assigned to each product upon correct classification. Examples of identification code may include, but not limited to, an alphanumeric code, a Universal Product Code, a barcode, a QR Code. Consequently, the first list is updated to include newly generated confidence score of classification of the product in the given case, along with the identification code.

The tracking algorithm tracks placement of cases on the given pallet, generates and maintains the tracking list, wherein the tracking list is a list of a set of cases being tracked to be placed on the given pallet at any given time. Additionally, optionally, the tracking list comprises the metadata of the bounding box for the list of the set of cases. Furthermore, the tracking list is used to keep an up-to date view of currently-visible cases placed on the given pallet as well as cases tracked to be placed on the given pallet in past. Optionally, the tracking list is indicative of tracking information of each case picked for the given pallet. Herein, the tracking information comprises further details pertaining to the given case, such as for example, information regarding placement of the given case on the given pallet, relative position of the given case with respect to another case, weight of the given case, and so forth. Herein, the count of cases picked per product is tracked by the tracking algorithm and is used in generating the tracking list. Moreover, correct quantities of each product in the given case must be packed and delivered in order to correctly fulfill an order (i.e., consignment). Additionally, the tracking list utilizes the first list in order to check whether the required case is already present in the tracking list or not. A given case that is already present in the tracking list is considered to be tracked and counted. Whenever a new case is added to the tracking list, the new case is also tracked and the count of cases picked per product is updated.

In an embodiment, the method comprises, prior to matching the given case in the first list with the set of cases in the tracking list, merging packs represented in the image frame to obtain a merged case using a mapping logic. Herein, the term “pack” is used to refer to a small-sized case, and multiple packs collectively constitute one unit (i.e., a large-sized case) that is transported together as a whole. Herein, the one unit is to be counted as one case. Therefore, the packs are merged to obtain the merged case which is counted as the one unit. For some products, a complete case is made up of a single pack. Such a step may be performed when the object detection model localizes the (individual) packs in the image frame instead of the merged case including such packs. In this regard, the object detection model may be used to identify the packs that constitute the merged case. Herein, the mapping logic is used to match the packs into the merged case, using a pre-defined finite set of rules so as to merge the packs and obtain the merged case. For instance, the mapping logic may be that four packs are to be merged to obtain one merged case. The object detection model detects the four packs but they are actually counted only as one merged case. Optionally, the merged case is added to the updated first list and is utilized when generating the tracking list. Optionally, the given case is directly identified in the first list without such merging.

Optionally, a step of employing the tracking algorithm for generating the tracking list comprises:
matching the given case in the first list with the set of cases in the tracking list;
determining that the given case is not to be added to the tracking list for counting, when the given case which matches with a case amongst the set of cases in the tracking list;
adding the given case which does not match with a case amongst the set of cases in the tracking list to a second list;
determining whether or not the given case that is added to the second list is to be subsequently counted, wherein the given case is determined to be subsequently counted, by being added to the tracking list when: the given case has been identified in at least a predefined number of image frames from amongst a set of consecutive image frames, and the confidence score of classification of the given case for said predefined number of image frames lies within a predefined confidence range;
adding the given case to the tracking list for counting the given case, when the given case is determined to be subsequently counted, wherein the count of cases picked for the given pallet is updated in real time or near-real time upon such adding.

Herein, the set of cases may include nil cases (for example, when no cases are currently tracked to be placed on the given pallet) or a finite number of cases. The given case in the first list is matched with the set of cases to check whether the given case is already tracked or not. The given case is already tracked when the given case matches with a case amongst the set of cases in the tracking list. In such an instance, the given case is not tracked again and is determined not to be subsequently counted, by not being added to the tracking list for counting. In other words, upon confirming presence of the given case in both the first list and the tracking list, the given case is not added to the set of cases in the tracking list to avoid double counting of the given case. Alternatively, when the given case does not match with any case amongst the set of cases in the tracking list, the given case is examined further for tracking. By the phrase “to be subsequently counted” it is meant that the given case is not counted already, and may be counted in future.

Furthermore, the second list comprises a list of cases that did not match (i.e., unmatched cases) with the set of cases in the tracking list. These cases are not tracked already. Herein, the at least one processor will access the first list to fetch the metadata of the unmatched cases over the image frames. The unmatched cases in the second list are determined to have gained maturity by getting identified and by getting classified confidently (i.e., for example, by having confidence score more than ‘70%’) by the classification algorithm in proper classes over at least the predefined number of image frames from amongst the set of consecutive image frames. Beneficially, this removes a possibility of adding random detections into the tracking list. Optionally, the step of employing the tracking algorithm for generating the tracking list further comprises retaining the given case in the second list, when the given case is determined as not to be subsequently counted. In an embodiment, a number of image frames in the set of consecutive image frames lies in a range of 5 to 30. For example, the set of consecutive image frames can include 5, 10, 12, 15, 20, 25, 30 frames, or similar. In an embodiment, the predefined number of image frames lies in a range of 30% to 70% of the number of image frames in the set of consecutive image frames. For example, the set of consecutive image frames includes 10 consecutive image frames and the predefined number of image frames is 40%. In such an example, if an unmatched case represented in at least 4 image frames out of the 10 consecutive image frames is classified confidently, the unmatched case is determined to have gained maturity. These at least 4 image frames need not be consecutive with respect to each other. The second list is maintained as a buffer list (or a waiting list) so that only those cases (from the first list) are added to the tracking list that maintain their position and class with high confidence scores over the predefined number of consecutive image frames. This allows the tracking algorithm to be confident that only the cases that have achieved required confidence score lying in the predefined confidence range are added to the tracking list. Herein, the predefined confidence range lies in a range of 51% to 100%. More optionally, the given list of cases is classified more confidently when the predefined confidence range lies in a range of 70% to 100%. For example, the predefined confidence range may be from 70, 75, 80, or 90% up to 80, 85, 90, 95 or 100%. In an example, a given case is detected by the object detection model for a set of 12 consecutive image frames, and is classified by the classification model to belong to a given class by way of having 12 confidence scores (of such classification) such as ‘60%’, ‘40%’, ‘32%’, ‘92%’, ‘89%’, ‘67%’, ‘84%’, ‘69%’, ‘98%’, ‘66%’, ‘60%’ and ‘90%’ corresponding to the 12 consecutive image frames. The high confidence score for at least 5 image frames from amongst the set of 12 consecutive image frames representing the given case indicates that the given case is to be added to the tracking list. Moreover, the cases that are able to leave the second list after attaining the confidence score enter the tracking list. Once the cases enter the tracking list, they are counted. Additionally, the count of cases picked for the given pallet is continuously updated with almost no lag (i.e., in real time or near-real time) to get a correct count of the number of cases added to the tracking list.

Optionally, the method comprises prior to adding the given case to the tracking list, determining whether the given case has been moved or has re-occurred, wherein the given case is added to the tracking list when it is determined that the given case has not been moved or has not re-occurred. If the given case is moved, then the same given case will be localized at different places in consecutive image frames. Movement of the given case may be identified when the person shuffles the set of cases, so as to structure the given pallet better. In another instance, when the given case has re-occurred in the consecutive image frames, the given case would appear in a few image frames and then would re-appeared in the consecutive image frames after being absent in some image frames. Furthermore, the re-occurred cases may be identified when the person moves or shuffles the set of cases, so as to structure the given pallet better. Herein, the pallets have a specific weight and/or dimensional capacity in order to transport the set of cases, and need to be structured so as to not break during transit. This is necessary as movement of the cases may introduce over-counting of products.

Throughout the present disclosure, the term “display device” relates to an electronic device that is capable of at least displaying an interactive user interface. The display device is associated with (or used by) a person, and is capable of enabling the person to perform specific tasks associated with the method. Furthermore, the display device is intended to be broadly interpreted to include any electronic device that may be used to facilitate interaction of the person using it, with the system. This interaction may be facilitated by one or more of a touch-sensitive screen of the display device, buttons on the display device, microphone on the display device, or similar. Examples of display device include, but are not limited to, a touch screen television (TV), tablets, laptop computers, personal computers, cellular phones, personal digital assistants (PDAs), handheld devices, etc. Additionally, the display device includes a casing, a memory, a processor, a network interface card, a microphone, a speaker, a keypad, and a display.

Throughout the present disclosure, the term “interactive user interface” relates to a structured set of interactive user interface elements rendered on a display. Optionally, the interactive user interface is generated by any collection or set of instructions executable by the at least one processor. Additionally, the interactive user interface is operable to interact with the person to convey graphical and/or textual information and receive input from the person. Furthermore, the interactive user interface elements refer to visual objects that have a size and position in the interactive user interface, and serve as a means of interacting with the person with respect to order picking. A given user interface element could be used to present/display an output, receive an input, or perform a combination of these. Text blocks, labels, text boxes, list boxes, lines, images windows, dialog boxes, frames, panels, menus, buttons, icons, statistical representations, and the like, are examples of interactive user interface elements. In addition to size and position, the interactive user interface element may have other properties, such as a margin, spacing, or the like.

The interactive user interface presents at least the count of cases picked per product. For instance, the required count of cases may be ‘5’, and is shown as such on the interactive user interface. However, only two cases are picked by the person and the order picking is ongoing. Hence, the interactive user interface will show the count of cases picked per product as ‘2’. The display device may also present the tracking list and tracking information of the given case in the given pallet. Herein, the tracking information may comprise identification code of shipment of the given pallet, identification number of the given pallet, door of the storage facility where the given pallet will be loaded for transportation, route the given pallet will take. Furthermore, the tracking information may further comprise identification code of the product in the given case, description of the product in the given case, bin number from where the product has been picked up to build the given case, a required count of cases to be picked per product for the given pallet, and the like.

Optionally, the method further comprises
presenting, on the interactive user interface, the required count of cases to be picked per product for the given pallet;
determining a picking status of a given product, based at least on the required count of cases to be picked per product for the given pallet, the count of cases picked per product for the given pallet, and whether picking of the cases for the given pallet is ongoing or completed;
displaying in real time, on the interactive user interface, the picking status of the given product.

Herein, on the interactive user interface, the person is shown real time updates regarding order picking. Furthermore, the picking status of the given product is one of: correctly picked, under picked, over picked, pending, picking in progress, incorrect product(s). Herein, the picking status of the given product is correctly picked, when the count of the cases that are picked per product for the given pallet is equal to the required count of cases to be picked per product, or the given case has been correctly identified as unavailable and has been marked as such, and the picking of the cases for the given pallet is completed. The picking status of the given product is under picked, when the count of cases that are picked per product is less than the required count of cases to be picked per product, and the picking of the cases for the given pallet is completed. The picking status of the given product is over picked, when the count of cases that are picked per product is greater than the required count of the cases to be picked per product, and the picking of the cases for the given pallet is completed. The picking status of the given product is pending, when the count of cases that are picked per product is zero, the required count of cases to be picked per product is non-zero, and the picking of the cases for the given pallet is ongoing. The picking status of the given product is picking in progress, when the count of cases picked per product is less than the required count of cases picked per product, and the picking of the cases for the given pallet is ongoing. The picking status of the given product is incorrect product(s), when the object detection model detects a given product that is picked to be other than a product required to build the given pallet.

Optionally, the picking status of the given product is determined based on accuracy of classification. Optionally, the method further comprises receiving, via the interactive user interface, an input indicative of a start of the picking of the cases for the given pallet and an input indicative of an end of the picking of the cases for the given pallet. Moreover, optionally, checkboxes to mark the given case as unavailable and incorrect count are also presented on the interactive user interface. This is to help with completion of the given pallet based on a current situation of itinerary in the storage facility. Subsequently, after completion of order picking, the count of the cases picked per product gets updated one final time.

Optionally, when displaying the picking status of the given product, the at least one processor is configured to display at least one of: a text indication of the picking status, a colour-coded indication of the picking status, an image indication of the picking status. In an instance, the required count of cases is ‘5’, the count of cases that are picked per product is less than the required count of cases to be picked per product, such as ‘2’, and the picking of the cases for the given pallet is completed, then the text indication of the picking status is shown as ‘Under picked’. Similarly, the text indication of the other picking statuses may be “Correctly picked”, “Over picked”, “Pending”, “Picking in progress”, “Incorrect product(s)”, and similar. In another instance, when the picking status of the given product is correctly picked, the colour-coded indication of the picking status is “green”; when the picking status of the given product is pending, the colour-coded indication of the picking status is “yellow”; and when the picking status of the given product is incorrect product(s), the colour-coded indication of the picking status is “red”. In yet another instance, when the picking status of the given product is correctly picked, the image indication of the given pallet is displayed.

In an embodiment, the method further comprises providing, at the display device or an output device, an alert indicative of mis-picking when the count of cases picked per product for the given pallet is not equal to the required count of cases to be picked per product for the given pallet and the picking of the cases is completed. Herein, the alert could be in the form of at least one of: a text, an image, an audio, a light signal, a haptic signal and so forth. The output device could be a buzzer, a loudspeaker, a light-emitting device, a haptic output device, and the like. When the alert is provided at the output device, the system further comprises the output device, and the output device is communicably coupled to the at least one processor. Furthermore, the alert is provided by sending from the at least one processor, an alert signal to the display device or the output device. The alert signal is provided, to the user, by the display device or the output device. Herein, the alert is easily perceived by the user, and prompts the user to correct the count of cases picked per product for the given pallet from user's end. Such automatic provision of the alert in the event of mis-picking enables in correction of such mis-picking to ensure accuracy of order picking.

Optionally, the method further comprises:
displaying, on the interactive user interface, a plurality of image frames that are captured while a person picks the cases for the given pallet;
receiving a first input validating authenticity of the plurality of image frames or a second input correcting a processing error;
storing, at a data repository, the plurality of image frames as a proof of shipment, when a given input is received; and
re-training at least one of: the object detection model, the classification model and/or updating the tracking algorithm, when the second input is received.

In this regard, interactive user interface displays the plurality of image frames representing the cases that are picked per product while the person picks the cases for the given pallet and enables the person to indicate any processing error, thereby acting as a feedback loop. The user's indication may also include a correct value/output of the processing error. Furthermore, the processing error comprises error pertaining to the plurality of image frames during erroneous execution of the object detection model, the classification model, or the training algorithm. In particular, the object detection model may wrongfully identify a product, and/or the classification model may classify the product in a wrong class, and/or the tracking list may show a wrong count of cases. Thereafter, the plurality of image frames is stored in the data repository, wherein the data repository may be a cloud-based storage, a local storage of the display device, an external storage communicably coupled to the display device, a remote storage of the display device and so forth. The proof of shipment may also comprise image segments representing the cases picked for the given pallet over course of the given pallet being built, in addition to the plurality of image frames. The first input validates authenticity of the plurality of image frames upon the person receiving visual proof for every case in the given pallet. The proof of shipment is stored irrespective of whether the processing error is present or not.

Optionally, the second input comprises the correct value/output of the processing error. Herein, based on the second input, the object detection model or the classification model are retrained, or the tracking list is updated. The retraining and the updating are performed so as to minimize the processing error. For example, the count of cases currently picked by the person is ‘5’, but the actual count of cases is ‘6’. Hence, the object detection model needs to be retrained in order to detect any missed cases.

Optionally, the method further comprises:
receiving and authenticating an identification code associated with the person;
obtaining information of pallets assigned to the person from a warehouse management system, based on the identification code;
displaying, on the interactive user interface, the information of pallets assigned to the person;
receiving, via the interactive user interface, a selection of the given pallet from amongst the pallets; and
receiving a confirmation of a working status of the camera.

In this regard, the person enters the identification code in the interactive user interface in order to start order-picking. Furthermore, the information of pallets comprises details of the pallets, such as locations of the pallets in the storage facility, total number of the pallets in the storage facility, types of the pallets, sizes of the pallets, cases to be picked for the pallets, statuses of the pallets, identification codes of the pallets, and so forth. Thereafter, based on authentication of the identification code associated with the person, the information of pallets assigned to the person is procured from the warehouse management system, and a correct picking status of the pallets is synchronized with the display device. The warehouse management system could be any system that enables in managing order fulfilment from a storage facility. Moreover, the person ensures that the camera is working properly and is positioned in a way so as to capture the image frame representing the pallet and the cases.

Optionally, the method comprises:
obtaining reference images representing cases of a plurality of products, the reference images being captured by the camera;
annotating the reference images; and
employing a machine learning algorithm for training the object detection model and the classification model using the annotated reference images.

In this regard, the reference images represent pallets, cases, packs present inside the storage facility. Herein, the reference images are obtained from the camera. Optionally, the reference images are annotated to record the reference images. Herein, annotation is performed to label or classify the reference images using text, or a drawing or both, to show features that the machine learning model must learn to recognize on its own upon training. The annotation may be either by performed manually by the person, or using a computer, wherein the annotation may be performed automatically using the computer or semi-automatically using a combination of the computer and manual input from the person. For instance, the storage facility comprises a first pallet, a second pallet, a first case, a second case, a first pack and a second pack. Subsequently, the reference image of the first pallet may be annotated to represent “Pallet 1”, the reference image of the second pallet may be annotated to represent “Pallet 2”, the reference image of the first case may be annotated to represent “Case 1”, the reference image of the second case may be annotated to represent “Case 2”, the reference image of the first pack may be annotated to represent “Pack 1”, and the reference image of the second pack may be annotated to represent “Pack 2”. Thereafter, a training data generated using the reference images are used to train the object detection model and the classification model. The machine learning algorithm utilizes the training data as an input for training a given model, to enable the given model in inferring a learning function based on the annotated reference images. This learning function is utilized by the given model when the given model is subsequently used after training. The machine learning algorithm may be at least one of: an object detection algorithm, a classification algorithm. Other machine learning algorithms may also be employed for training. Such machine learning algorithms are well-known in the art.

In an embodiment, the tracking algorithm is updated according to the object detection model and the classification model that are trained. Thereafter, the object detection model, the classification model, and the training algorithm are integrated into an inference pipeline. Herein, the inference pipeline is a sequence of processing steps that are required to be performed for implementing the method for order picking. Furthermore, the inference pipeline is deployed (for example, on system components such as the camera, at least one processor, and similar).

The present disclosure also relates to the system as described above. Various embodiments and variants disclosed above apply mutatis mutandis to the system.

Optionally, the camera is arranged to face forks of the pallet jack, and is mounted on the pallet jack at a position that is at a predetermined distance from a base of the pallet jack, wherein the predetermined distance lies in a range of 60 inches to 120 inches. As an example, the predetermined distance may be from 60, 70, 80, 90, or 100 inches up to 65, 75, 85, 95, 105, 115 or 120 inches. The display device and the at least one processor are also arranged on the pallet jack. The camera is mounted on a movable contraption to adjust the pose (i.e., position and/or orientation) of the camera so as to get a proper view of the pallet when cases are picked and kept on the pallet. The orientation of the camera is adjusted by adjusting an angle of the camera. Furthermore, the camera is able to swivel to adjust its perspective, so as to capture the image frames of all the cases in vicinity of the pallet jack. Optionally, the position of the camera depends on at least one of: dimensions of the pallet jack, dimensions of the given pallet arranged on the pallet jack, a field of view of the camera. The position of the camera is maintained by the person in such a way so that required views of the cases placed on the pallet are continuously captured. These views may also represent portions of one or more of the pallet, the pallet jack, surroundings of the pallet jack, the person, or similar.

Optionally, when employing the tracking algorithm for generating the tracking list, the at least one processor is configured to:
match the given case in the first list with a set of cases in the tracking list;
determine that the given case is not to be added to the tracking list for counting, when the given case which matches with a case amongst the set of cases in the tracking list;
add the given case which does not match with a case amongst the set of cases in the tracking list to a second list;
determine whether or not the given case that is added to the second list is to be subsequently counted, wherein the given case is determined to be subsequently counted, by being added to the tracking list when: the given case has been identified in at least a predefined number of image frames from amongst a set of consecutive image frames, and the confidence score of classification of the given case for said predefined number of image frames lies within a predefined confidence range;
add the given case to the tracking list for counting the given case, when the given case is determined to be subsequently counted, wherein the count of cases picked per product for the given pallet is updated in real time or near-real time upon such adding.

Optionally, the at least one processor is further configured to, prior to matching the given case in the first list with the set of cases in the tracking list, merge packs represented in the image frame to obtain a merged case using a mapping logic.

Optionally, the at least one processor is further configured to, prior to adding the given case to the tracking list, determine whether the given case has been moved or has re-occurred, wherein the given case is added to the tracking list when it is determined that the given case has not been moved or has not re-occurred.

Optionally, the at least one processor is further configured to:
present, on the interactive user interface, a required count of cases to be picked per product for the given pallet;
determine a picking status of a given product, based at least on the required count of cases to be picked per product for the given pallet, the count of cases picked per product for the given pallet, and whether picking of the cases for the given pallet is ongoing or completed;
display in real time, on the interactive user interface, the picking status of the given product.

Optionally, the at least one processor is further configured to provide, at the display device or an output device, an alert indicative of mis-picking when the count of cases picked per product for the given pallet is not equal to a required count of cases to be picked per product for the given pallet and picking of the cases is completed.

Optionally, the at least one processor is further configured to:
display, on the interactive user interface, a plurality of image frames that are captured while a person picks the cases for the given pallet;
receive a first input validating authenticity of the plurality of image frames or a second input correcting a processing error;
store, at a data repository, the plurality of image frames as a proof of shipment, when a given input is received; and
re-train at least one of: the object detection model, the classification model and/or update the tracking algorithm, when the second input is received.

Optionally, the at least one processor is further configured to:
obtain reference images representing cases of a plurality of products, the reference images being captured by the camera;
annotate the reference images; and
employ a machine learning algorithm for training the object detection model and the classification model using the annotated reference images.

Optionally, the at least one processor is further configured to:
receive and authenticate an identification code associated with the person;
obtain information of pallets assigned to the person from a warehouse management system, based on the identification code;
display, on the interactive user interface, the information of pallets assigned to the person;
receive, via the interactive user interface, a selection of the given pallet from amongst the pallets; and
receive a confirmation of a working status of the camera.

### DETAILED DESCRIPTION OF THE DRAWINGS

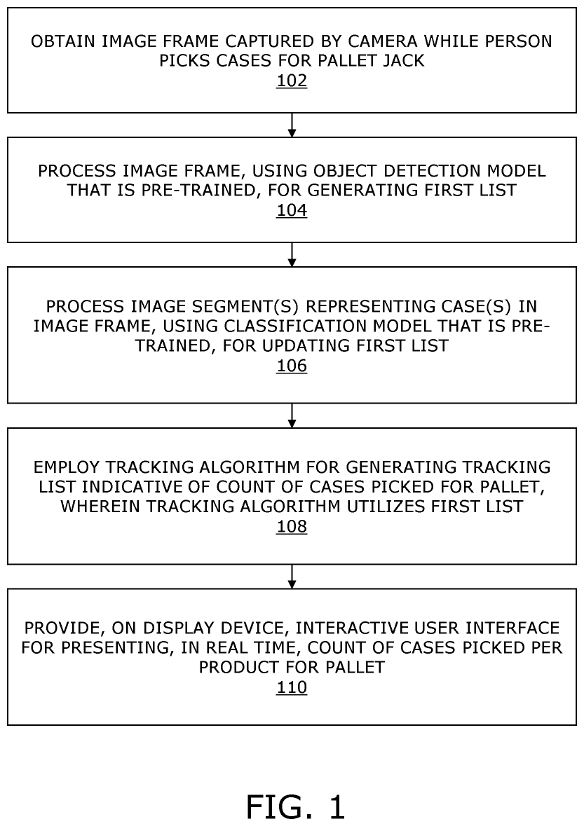

Referring to FIG. 1, illustrated are steps of a method for order picking, in accordance with an embodiment of the present disclosure. At step 102, an image frame is captured by a camera arranged on a pallet jack. The image frame represents a view of cases picked for a given pallet that is arranged on the pallet jack. At step 104, the image frame is processed, using an object detection model that is pre-trained, for generating a first list. The object detection model at least identifies and localizes at least one case represented in the image frame. The first list includes at least one entry per image frame, a given entry corresponding to a given case that is identified to be arranged on the given pallet in a given frame and metadata of a bounding box for the given case. At step 106, at least one image segment representing the at least one case in the image frame is processed, using a classification model that is pre-trained, for updating the first list. The classification model classifies a product in the given case as belonging to a given class, predicts a confidence score of said classification and generates an identification code of the product. The first list is updated by adding the confidence score and the identification code to the given entry. At step 108, a tracking algorithm is employed for generating a tracking list indicative of at least a count of cases picked per product for the given pallet, wherein the tracking algorithm utilizes the first list. At step 110, there is provided, on a display device, an interactive user interface for presenting, in real time, at least the count of cases picked per product for the given pallet.

The aforementioned steps are only illustrative and other alternatives can also be provided where one or more steps are added, one or more steps are removed, or one or more steps are provided in a different sequence without departing from the scope of the claims herein.

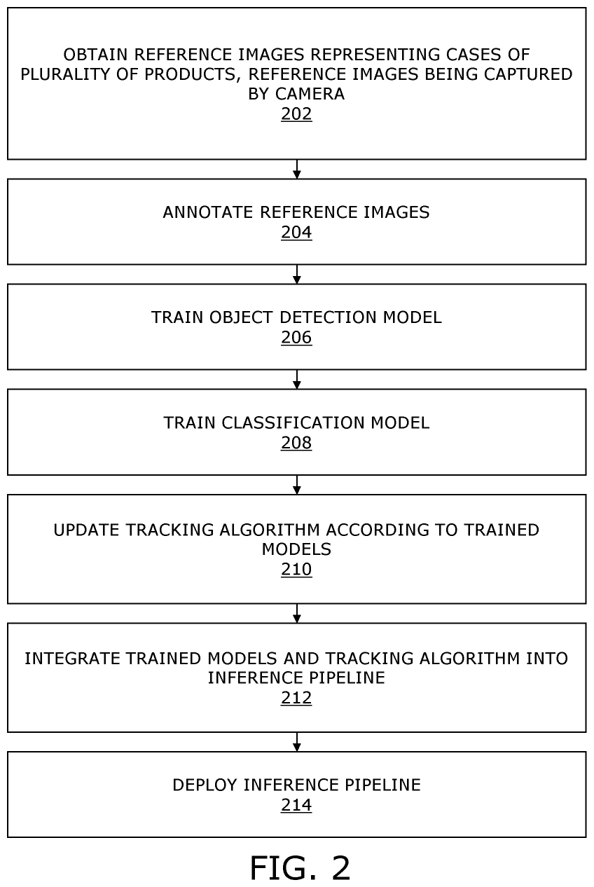

Referring to FIG. 2, illustrated is an exemplary process flow of a method for order picking, in accordance with an embodiment of the present disclosure. The exemplary process flow is implemented prior to employing the method for order picking.

At step 202, reference images representing cases of a plurality of products, the reference images being captured by the camera is obtained. At step 204, reference images are annotated. At step 206, the object detection model is trained using the reference images. At step 208, the classification model is trained using the reference images. A machine learning algorithm is employed for training said models at steps 206 and 208. At step 210, a tracking algorithm is updated according to the object detection model and the classification model that are trained. At step 212, the object detection model, the classification model, and the training algorithm are integrated into an inference pipeline. At step 214, the inference pipeline is deployed (for example, on system components such as the camera, at least one processor, and similar).

The aforementioned steps are only illustrative and other alternatives can also be provided where one or more steps are added, one or more steps are removed, or one or more steps are provided in a different sequence without departing from the scope of the claims herein.

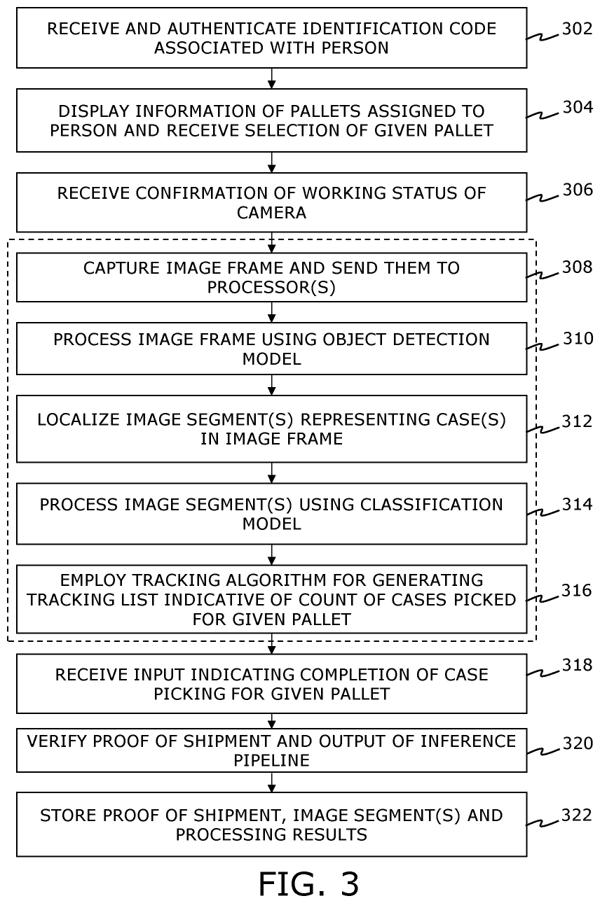

Referring to FIG. 3, illustrated is an exemplary detailed high-level process flow of a method for order picking, in accordance with an embodiment of the present disclosure. This process flow is implemented, for example, every time that a pallet is packed.

At step 302, an identification code associated with a person is received and authenticated. At step 304, information of pallets assigned to the person is obtained from a warehouse management system, based on the identification code, said information is displayed on an interactive user interface, and a selection of a given pallet from amongst the pallets is received. At step 306, a confirmation of a working status of the camera is received. Additionally, the person may click on a button, presented on the interactive user interface, to indicate start of order picking for the given pallet.

At step 308, the camera captures an image frame and sends them to at least one processor. At step 310, the image frame are processed using an object detection model that is pre-trained. The object detection model at least identifies and localizes at least one case represented in the image frame. Upon such processing, a first list is generated. At step 312, at least one image segment representing the at least one case in the image frame is cropped and sent to a classification model. At step 314, the at least one image segment is processed using the classification model that is pre-trained. The classification model classifies a product in the given case as belonging to a given class, predicts a confidence score of said classification and generates an identification code of the product. Upon such processing, the first list is updated. At step 316, a tracking algorithm is employed for generating a tracking list indicative of at least a count of cases picked per product for the given pallet.

At step 318, an input indicating completion of case picking for the given pallet is received. The person may click on a button, presented on the interactive user interface, to indicate end of order picking for the given pallet. At step 320, proof of shipment and output of inference pipeline are verified by the person who picked the cases for the given pallet. If any processing errors are identified by the person, the person provides a corresponding input and at least one of: the object detection model, the classification model is re-trained and/or the tracking algorithm is updated accordingly. At step 322, a proof of shipment, the at least one image segment and processing results (i.e., the first list, the tracking list, the output of inference pipeline, and the like) are sent for storage, at a data repository.

The aforementioned steps are only illustrative and other alternatives can also be provided where one or more steps are added, one or more steps are removed, or one or more steps are provided in a different sequence without departing from the scope of the claims herein.

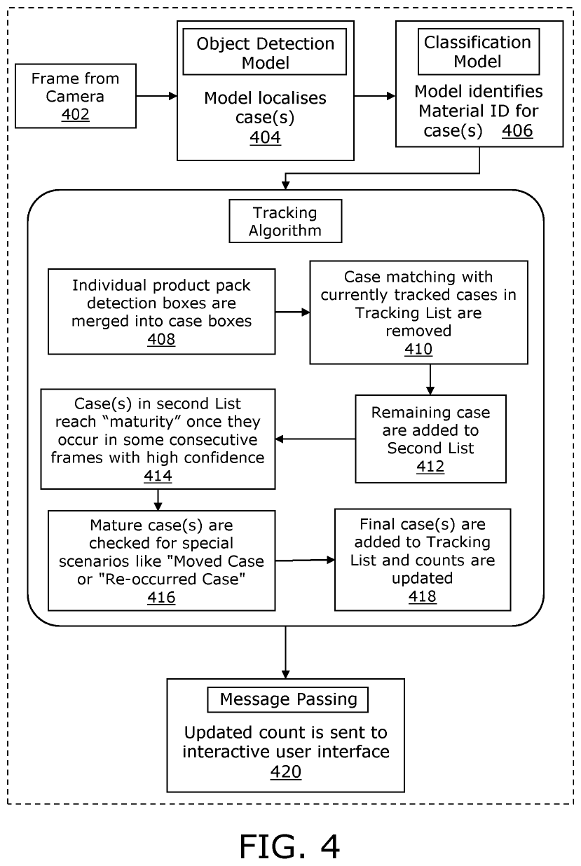

Referring to FIG. 4, illustrated is an exemplary processing sequence for each image frame, with focus on a tracking algorithm, in accordance with an embodiment of the present disclosure. At 402, an image frame is received from a camera. At 404, the image frame is processed by an object detection model. Case(s) represented in the image frame are localized and optionally, their substrate is identified. At 406, an image segment of the image frame which represents the case(s) is processed by a classification model. The classification model classifies a product in the given case as belonging to a given class, predicts a confidence score of said classification and generates an identification code (i.e., material ID) of the product. At 408, packs (of products) represented in the image frame are merged using a mapping logic to obtain merged case(s). At 410, a given case (i.e., a merged case or a case directly identified in a first list without such merging) is matched with cases amongst the set of cases in a tracking list. When the given case matches with a case amongst the set of cases in the tracking list, the given case is removed from consideration and is not added to the tracking list (as the given case is considered to already be tracked). At 412, a given case which does not match with a case amongst the set of cases in the tracking list is added to a second list. At 414, it is determined whether or not the given case that is added to the second list is to be counted (i.e., whether the given case has attained maturity). The given case is determined to be added to the tracking list when: the given case has been identified in at least a predefined number of image frames from amongst a set of consecutive image frames, and the confidence score of classification of the given case for said predefined number of image frames lies within a predefined confidence range. At 416, it is determined whether the given case has been moved or has re-occurred. At 418, the given case is added (from the second list) to the tracking list when it is determined that the given case has not been moved or has not re-occurred. Upon said addition, a count of cases picked per product for the given pallet is updated. At 420, the updated count of cases picked per product for the given pallet is presented on an interactive user interface, wherein the interactive user interface is provided on a display device.

The aforementioned steps are only illustrative and other alternatives can also be provided where one or more steps are added, one or more steps are removed, or one or more steps are provided in a different sequence without departing from the scope of the claims herein.

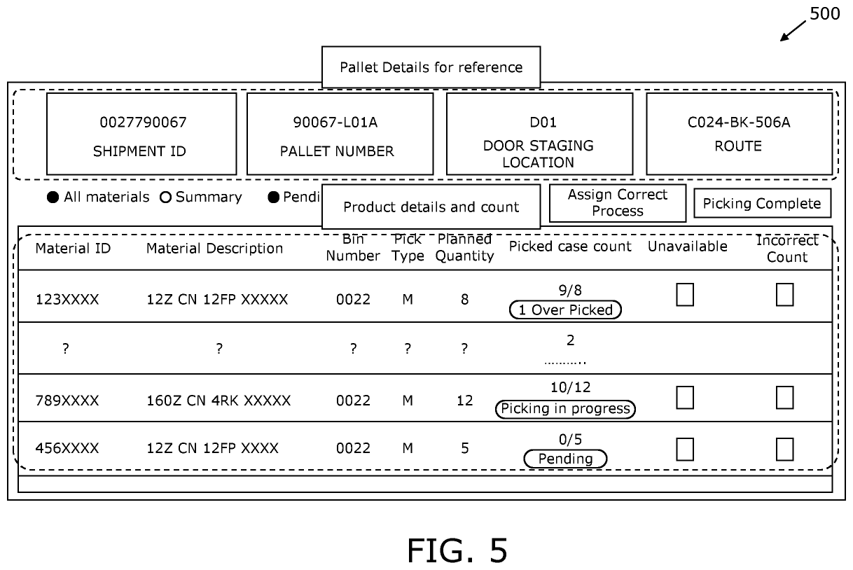

Referring to FIG. 5, illustrated is an exemplary interactive user interface 500, in accordance with an embodiment of the present disclosure. The interactive user interface 500 is provided, for example, on a display device. On the interactive user interface 500, there is presented a count of cases picked per product for a given pallet under column “Picked case count”. There are also presented a required count of cases to be picked per product for the given pallet under columns “Planned Quantity” and “Picked case count”. For example, a first entry in the column ‘Picked case count’ is ‘9/8’, wherein the count of cases picked per product for the given pallet is ‘9’ and the required count of cases to be picked per product for the given pallet is ‘8’. Furthermore, an identification code of products in a given case is presented under column “Material ID”, while a classification of such products is presented under column “Material Description”. There is also displayed on the interactive user interface 500, a picking status of each product. For example, the picking status of a product corresponding to the first entry shown is “Over picked”. The interactive user interface 500 also includes input fields to enable a person picking cases for the given pallet to indicate if the product is unavailable or if a processing error has occurred. The interactive user interface 500 is also shown to include details such as shipment ID, pallet number, staging location, route, and the like.

It may be understood by a person skilled in the art that FIG. 5 represents an exemplary interactive user interface 500 for sake of clarity, which should not unduly limit the scope of the claims herein. The person skilled in the art will recognize many variations, alternatives, and modifications of embodiments of the present disclosure.

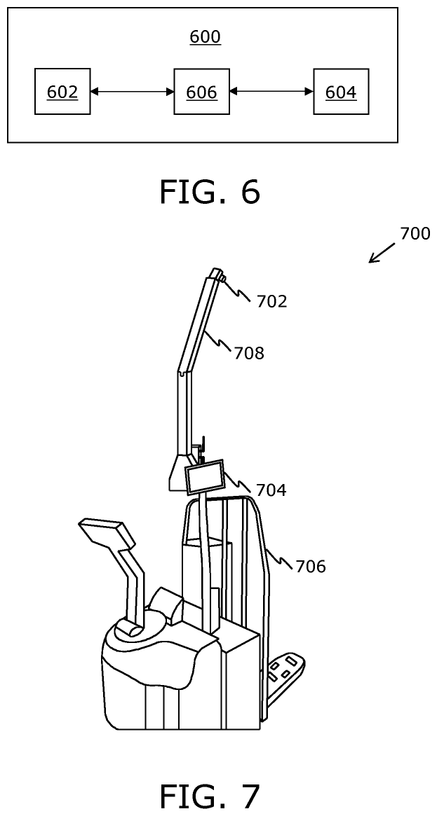

Referring to FIG. 6, illustrated is an architecture of a system 600 for order picking, in accordance with an embodiment of the present disclosure. The system 600 comprises a camera (depicted as a camera 602), a display device (depicted as a display device 604) and at least one processor (depicted as a processor 606). The at least one processor 606 is communicably coupled with the camera 602 and the display device 604. The at least one processor 606 may be implemented as a graphical processing unit. The system 600 can be understood to be an AI-based kit that can be easily attached to a pallet jack (not shown) for use.

Referring to FIG. 7, illustrated is schematic illustration of a system 700 for order picking, in accordance with an embodiment of the present disclosure. The system 700 comprises a camera 702, a display device 704, and at least one processor (not shown) arranged on a pallet jack 706. The camera 702 is mounted on a contraption 708.

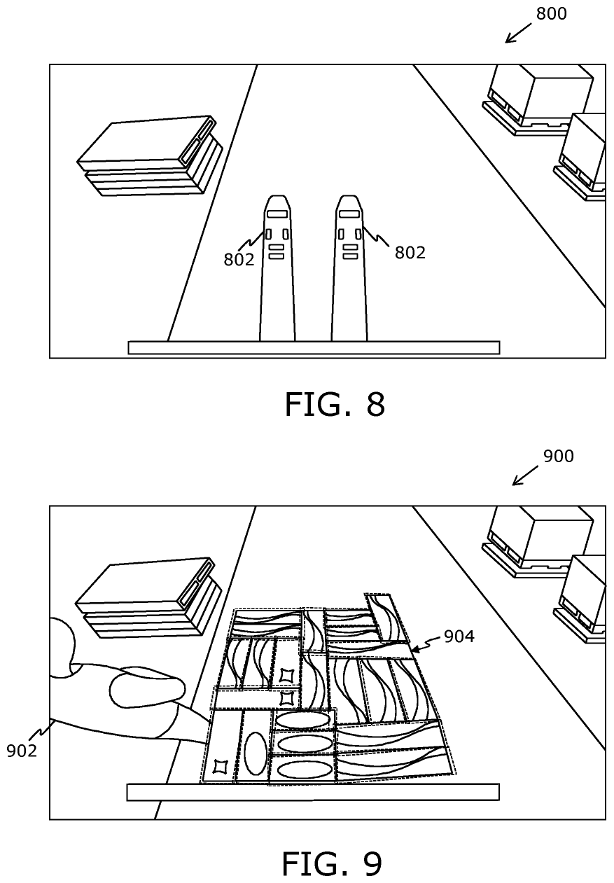

Referring to FIGS. 8 and 9, illustrated are views 800 and 900 respectively, that are captured by a camera mounted on a pallet jack, in accordance with an embodiment of the present disclosure. The camera is arranged to face a base of the pallet jack. Furthermore, the camera is mounted on the pallet jack at a position that is at a predetermined distance from the base of the pallet jack.

In the view 800, there are shown forks 802 of the pallet jack. Herein, order picking has not commenced, as a pallet has not been placed on the forks 802. The camera faces the forks 802 and is adjusted by a person before order picking to have a proper view, wherein the camera captures image frames of pallet and the cases placed upon the pallet once order picking commences.

In the view 900, there are shown cases placed on the pallet since order picking has started. Herein, the view 900 in an image frame represents a top portion of cases placed on the pallet as the cases are piled one by one on top of each other, on the pallet. A person 902 may be performing the order picking, and may have previously adjusted a pose of the camera to capture the view 900. The image frame is obtained for processing using an object detection model in real time. The object detection model at least identifies and localizes a plurality of cases 904, and identifies bounding boxes (denoted by dashed lines) surrounding the plurality of cases 904 in the image frame. The plurality of cases 904 are shown to represent various types of products (depicted as products with different logos and designs).

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for order picking, the method comprising:
obtaining an image frame captured by a camera arranged on a pallet jack, wherein the image frame represents a view of cases picked for a given pallet that is arranged on the pallet jack;
processing the image frame, using an object detection model that is pre-trained, for generating a first list, wherein the object detection model at least identifies and localizes at least one case represented in the image frame, and wherein the first list includes at least one entry per image frame, a given entry corresponding to a given case that is identified to be arranged on the given pallet in a given frame and metadata of a bounding box for the given case;
processing at least one image segment representing the at least one case in the image frame, using a classification model that is pre-trained, for updating the first list, wherein the classification model classifies a product in the given case as belonging to a given class, predicts a confidence score of said classification and generates an identification code of the product, and wherein the first list is updated by adding the confidence score and the identification code to the given entry;
employing a tracking algorithm for generating a tracking list indicative of at least a count of cases picked per product for the given pallet, wherein the tracking algorithm utilizes the first list; and
providing, on a display device, an interactive user interface for presenting, in real time at least the count of cases picked per product for the given pallet.

2. The method according to claim 1, wherein the step of employing the tracking algorithm for generating the tracking list comprises:
matching the given case in the first list with a set of cases in the tracking list;
determining that the given case is not to be added to the tracking list for counting, when the given case which matches with a case amongst the set of cases in the tracking list;
adding the given case which does not match with a case amongst the set of cases in the tracking list to a second list;
determining whether or not the given case that is added to the second list is to be subsequently counted, wherein the given case is determined to be subsequently counted, by being added to the tracking list when: the given case has been identified in at least a predefined number of image frames from amongst a set of consecutive image frames, and the confidence score of classification of the given case for said predefined number of image frames lies within a predefined confidence range;
adding the given case to the tracking list for counting the given case, when the given case is determined to be subsequently counted, wherein the count of cases picked per product for the given pallet is updated in real time or near-real time upon such adding.

3. The method according to claim 2, further comprising, prior to matching the given case in the first list with the set of cases in the tracking list, merging packs represented in the image frame to obtain a merged case using a mapping logic.

4. The method according to claim 2, further comprising, prior to adding the given case to the tracking list, determining whether the given case has been moved or has re-occurred, wherein the given case is added to the tracking list when it is determined that the given case has not been moved or has not re-occurred.

5. The method according to claim 1, further comprising:
presenting, on the interactive user interface, a required count of cases to be picked per product for the given pallet;
determining a picking status of a given product, based at least on the required count of cases to be picked per product for the given pallet, the count of cases picked per product for the given pallet, and whether picking of the cases for the given pallet is ongoing or completed;
displaying in real time, on the interactive user interface, the picking status of the given product.

6. The method according to claim 5, further comprising providing, at the display device or an output device, an alert indicative of mis-picking when the count of cases picked per product for the given pallet is not equal to a required count of cases to be picked per product for the given pallet and picking of the cases is completed.

7. The method according to claim 1, further comprising:
displaying, on the interactive user interface, a plurality of image frames that are captured while a person picks the cases for the given pallet;
receiving a first input validating authenticity of the plurality of image frames or a second input correcting a processing error;
storing, at a data repository, the plurality of image frames as a proof of shipment, when a given input is received; and
re-training at least one of: the object detection model, the classification model and/or updating the tracking algorithm, when the second input is received.

8. The method according to claim 1, further comprising:
obtaining reference images representing cases of a plurality of products, the reference images being captured by the camera;
annotating the reference images; and
employing a machine learning algorithm for training the object detection model and the classification model using the annotated reference images.

9. The method according to claim 7, further comprising:
receiving and authenticating an identification code associated with the person;
obtaining information of pallets assigned to the person from a warehouse management system, based on the identification code;
displaying, on the interactive user interface, the information of pallets assigned to the person;
receiving, via the interactive user interface, a selection of the given pallet from amongst the pallets; and
receiving a confirmation of a working status of the camera.

10. A system for order picking, the system comprising a camera, a display device, and at least one processor, wherein the at least one processor is configured to:
obtain an image frame captured by the camera arranged on a pallet jack, wherein the image frame represents a view of cases picked for a given pallet that is arranged on the pallet jack;
process the image frame, using an object detection model that is pre-trained, for generating a first list, wherein the object detection model at least identifies and localizes at least one case represented in the image frame, and wherein the first list includes at least one entry per image frame, a given entry corresponding to a given case that is identified to be arranged on the given pallet in a given frame and metadata of a bounding box for the given case;
process at least one image segment representing the at least one case in the image frame, using a classification model that is pre-trained, for updating the first list, wherein the classification model classifies a product in the given case as belonging to a given class, predicts a confidence score of said classification and generates an identification code of the product, and wherein the first list is updated by adding the confidence score and the identification code to the given entry;
employ a tracking algorithm for generating a tracking list indicative of at least a count of cases picked per product for the given pallet, wherein the tracking algorithm utilizes the first list; and
provide, on the display device, an interactive user interface for presenting, in real time, at least the count of cases picked per product for the given pallet.

11. The system according to claim 10, wherein the camera is arranged to face forks of the pallet jack, and is mounted on the pallet jack at a position that is at a predetermined distance from a base of the pallet jack, wherein the predetermined distance lies in a range of 60 inches to 120 inches.

12. The system according to claim 10, wherein when employing the tracking algorithm for generating the tracking list, the at least one processor is configured to:
match the given case in the first list with a set of cases in the tracking list;
determine that the given case is not to be added to the tracking list for counting, when the given case which matches with a case amongst the set of cases in the tracking list;
add the given case which does not match with a case amongst the set of cases in the tracking list to a second list;
determine whether or not the given case that is added to the second list is to be subsequently counted, wherein the given case is determined to be subsequently counted, by being added to the tracking list when: the given case has been identified in at least a predefined number of image frames from amongst a set of consecutive image frames, and the confidence score of classification of the given case for said predefined number of image frames lies within a predefined confidence range;
add the given case to the tracking list for counting the given case, when the given case is determined to be subsequently counted, wherein the count of cases picked per product for the given pallet is updated in real time or near-real time upon such adding.

13. The system according to claim 12, wherein the at least one processor is further configured to, prior to matching the given case in the first list with the set of cases in the tracking list, merge packs represented in the image frame to obtain a merged case using a mapping logic.

14. The system according to claim 12, wherein the at least one processor is further configured to, prior to adding the given case to the tracking list, determine whether the given case has been moved or has re-occurred, wherein the given case is added to the tracking list when it is determined that the given case has not been moved or has not re-occurred.

15. The system according to the claim 10, wherein the at least one processor is further configured to:
present, on the interactive user interface, a required count of cases to be picked per product for the given pallet;
determine a picking status of a given product, based at least on the required count of cases to be picked per product for the given pallet, the count of cases picked per product for the given pallet, and whether picking of the cases for the given pallet is ongoing or completed;
display in real time, on the interactive user interface, the picking status of the given product.

16. The system according to claim 15, wherein the at least one processor is further configured to provide, at the display device or an output device, an alert indicative of mis-picking when the count of cases picked per product for the given pallet is not equal to a required count of cases to be picked per product for the given pallet and picking of the cases is completed.

17. The system according to claim 10, wherein the at least one processor is further configured to:
display, on the interactive user interface, a plurality of image frames that are captured while a person picks the cases for the given pallet;
receive a first input validating authenticity of the plurality of image frames or a second input correcting a processing error;
store, at a data repository, the plurality of image frames as a proof of shipment, when a given input is received; and
re-train at least one of: the object detection model, the classification model and/or update the tracking algorithm, when the second input is received.

18. The system according to claim 10, wherein the at least one processor is further configured to:
obtain reference images representing cases of a plurality of products, the reference images being captured by the camera;
annotate the reference images; and
employ a machine learning algorithm for training the object detection model and the classification model using the annotated reference images.

19. The system according to claim 17, wherein the at least one processor is further configured to:
receive and authenticate an identification code associated with the person;
obtain information of pallets assigned to the person from a warehouse management system, based on the identification code;
display, on the interactive user interface, the information of pallets assigned to the person;
receive, via the interactive user interface, a selection of the given pallet from amongst the pallets; and
receive a confirmation of a working status of the camera.
